(19) United States
(12) Patent Application Publication
(10) Pub. No.: US 2026/0172953 A1
(43) Pub. Date: Jun. 18, 2026

(54) CONDITIONALLY AVAILABLE NETWORK SLICES

(71) Applicant: QUALCOMM Incorporated, San Diego, CA (US)

(72) Inventors: Stefano FACCIN, San Ysidro, CA (US); Lenaig Genevieve CHAPONNIERE, La Jolla, CA (US); Amer CATOVIC, San Diego, CA (US); Haris ZISIMOPOULOS, London (GB); Sunghoon KIM, San Diego, CA (US)

(21) Appl. No.: 18/707,744

(22) PCT Filed: Dec. 14, 2022
(86) PCT No.: PCT/US2022/081577

§ 371 Date: May 6, 2024

(30) Foreign Application Priority Data
Jan. 28, 2022 (GR) 20220100084

(51) Int. Cl. H04W 48/18; H04W 48/02; H04W 60/04; H04W 76/30

(52) U.S. Cl. CPC H04W 48/18; H04W 48/02; H04W 60/04; H04W 76/30

(57) ABSTRACT

Various aspects of the present disclosure generally relate to wireless communication. In some aspects, a user equipment (UE) may transmit, after entering a first cell of a first tracking area, a request to connect to a set of network slices. The UE may receive an indication of conditional availability of one or more network slices in the set of network slices. Numerous other aspects are described. WO

### CROSS-REFERENCE TO RELATED APPLICATION

This Patent Application claims priority to Greece Patent Application No. 20220100084, filed on Jan. 28, 2022, and entitled “CONDITIONALLY AVAILABLE NETWORK SLICES.” The disclosure of the prior Application is considered part of and is incorporated by reference into this Patent Application.

### FIELD OF THE DISCLOSURE

Aspects of the present disclosure generally relate to wireless communication and to techniques and apparatuses for accessing conditionally available network slices.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting, after entering a first cell of a first tracking area, a request to connect to a set of network slices. The method may include receiving an indication of conditional availability of one or more network slices in the set of network slices.

Some aspects described herein relate to a method of wireless communication performed by a network entity. The method may include receiving a request to connect to a set of network slices. The method may include transmitting a first response to the request based at least in part on a conditional availability of one or more network slices in the set of network slices, wherein the first response includes an indication of the conditional availability of the one or more network slices.

Some aspects described herein relate to a UE for wireless communication. The UE may include a memory and one or more processors coupled to the memory.

The one or more processors may be configured to transmit, after entering a first cell of a first tracking area, a request to connect to a set of network slices. The one or more processors may be configured to receive an indication of conditional availability of one or more network slices in the set of network slices.

Some aspects described herein relate to a network entity for wireless communication. The network entity may include a memory and one or more processors coupled to the memory. The one or more processors may be configured to receive a request to connect to a set of network slices. The one or more processors may be configured to transmit a first response to the request based at least in part on a conditional availability of one or more network slices in the set of network slices, wherein the first response includes an indication of the conditional availability of the one or more network slices.

Some aspects described herein relate to a non-transitory computer-readable medium that stores a set of instructions for wireless communication by a UE. The set of instructions, when executed by one or more processors of the UE, may cause the UE to transmit, after entering a first cell of a first tracking area, a request to connect to a set of network slices. The set of instructions, when executed by one or more processors of the UE, may cause the UE to receive an indication of conditional availability of one or more network slices in the set of network slices.

Some aspects described herein relate to a non-transitory computer-readable medium that stores a set of instructions for wireless communication by a network entity. The set of instructions, when executed by one or more processors of the network entity, may cause the network entity to receive a request to connect to a set of network slices. The set of instructions, when executed by one or more processors of the network entity, may cause the network entity to transmit a first response to the request based at least in part on a conditional availability of one or more network slices in the set of network slices, wherein the first response includes an indication of the conditional availability of the one or more network slices.

Some aspects described herein relate to an apparatus for wireless communication. The apparatus may include means for transmitting, after entering a first cell of a first tracking area, a request to connect to a set of network slices. The apparatus may include means for receiving an indication of conditional availability of one or more network slices in the set of network slices.

Some aspects described herein relate to an apparatus for wireless communication. The apparatus may include means for receiving a request to connect to a set of network slices. The apparatus may include means for transmitting a first response to the request based at least in part on a conditional availability of one or more network slices in the set of network slices, wherein the first response includes an indication of the conditional availability of the one or more network slices.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram of an example of a core network configured to provide network slicing, in accordance with the present disclosure.

FIG. 5 is a diagram illustrating an example of requesting network slices, in accordance with the present disclosure.

FIG. 6 is a diagram illustrating an example of indicating conditional availability of network slices, in accordance with the present disclosure.

FIG. 7 is a diagram illustrating an example process performed, for example, by a UE, in accordance with the present disclosure.

FIG. 8 is a diagram illustrating an example process performed, for example, by a network entity, in accordance with the present disclosure.

FIGS. 9-10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

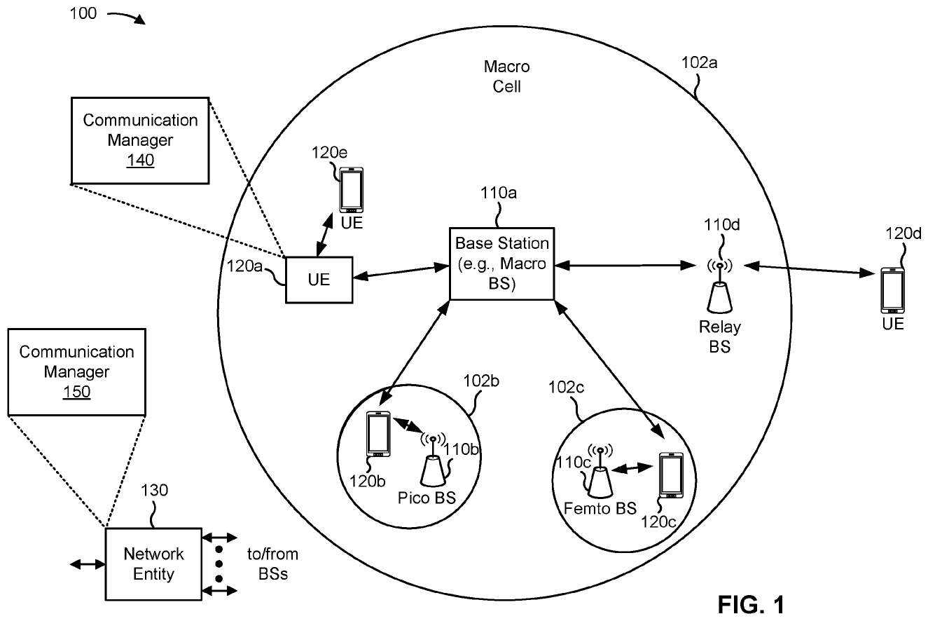

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, a core network node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the terms “base station” or “network entity” may refer to one device configured to perform one or more functions, such as those described herein in connection with the base station 110. In some aspects, the terms “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the terms “base station” or “network entity” may refer to any one or more of those different devices. In some aspects, the terms “base station” or “network entity” may refer to one or more virtual base stations and/or one or more virtual base station functions. For example, in some aspects, two or more base station functions may be instantiated on a single device. In some aspects, the terms “base station” or “network entity” may refer to one of the base station functions and not another. In this way, a single device may include more than one base station.

The wireless network 100 may include one or more relay stations. A relay station is a base station 110 that can receive a transmission of data from an upstream station (e.g., a network entity 130) and send a transmission of the data to a downstream station (e.g., a UE 120). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with base stations that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller may couple to or communicate with a set of network entities and may provide coordination and control for these network entities. The network controller may communicate with the base stations 110 via a backhaul communication link. The network entities may communicate with one another directly or indirectly via a wireless or wireline backhaul communication link. For example, a network entity 130 may include a core network component that can communicate with a UE 120 via the base station 110.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, after entering a first cell of a first tracking area, a request to connect to a set of network slices. The communication manager 140 may receive an indication of conditional availability of one or more network slices in the set of network slices. Additionally, or alternatively, the communication manager 140 may perform one or more other operations described herein.

In some aspects, the network entity may include a communication manager 150. As described in more detail elsewhere herein, the communication manager 150 may receive a request to connect to a set of network slices. The communication manager 150 may transmit a first response to the request based at least in part on a conditional availability of one or more network slices in the set of network slices, wherein the first response includes an indication of the conditional availability of the one or more network slices. Additionally, or alternatively, the communication manager 150 may perform one or more other operations described herein.

As indicated above, FIG. 1 is provided as an example. Other examples may differ from what is described with regard to FIG. 1.

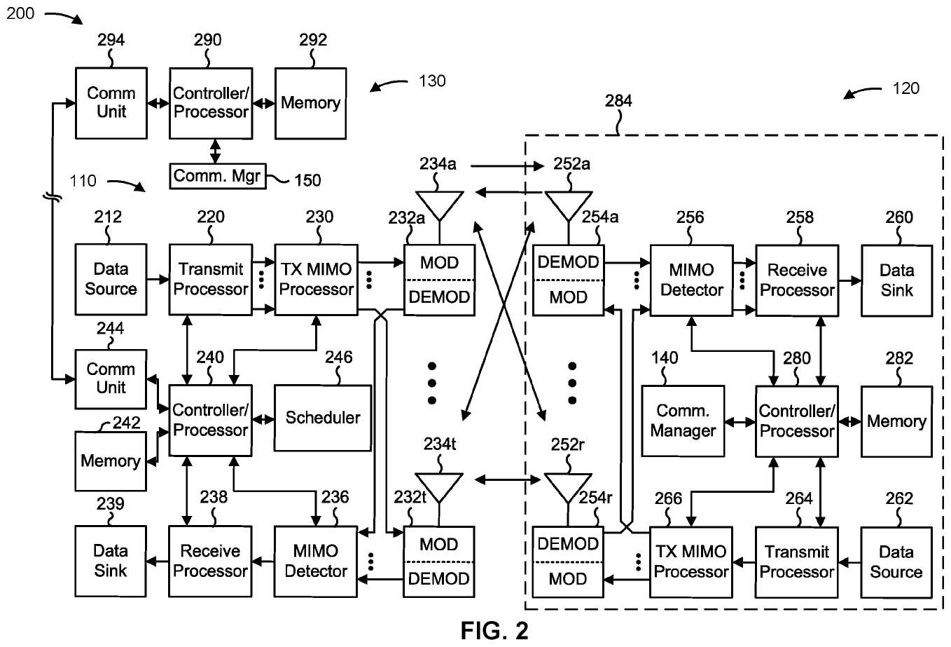

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network entity 130 may include a communication unit 294, a controller/processor 290, and a memory 292. The network entity 130 may include, for example, one or more devices in a core network. The network entity 130 may communicate with the base station 110, other network entities, or other components of the core network via the communication unit 294. The network entity may include a communication manager 150.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

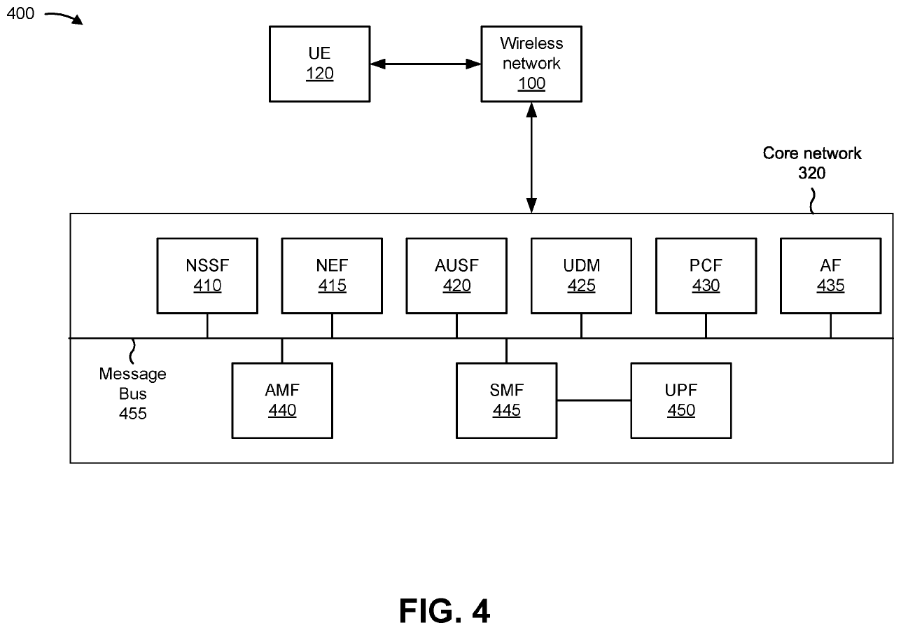

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network entity (e.g., network entity 130), the uplink signals from UE 120 and/or other UEs may be received via a base station 110 by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network entity 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

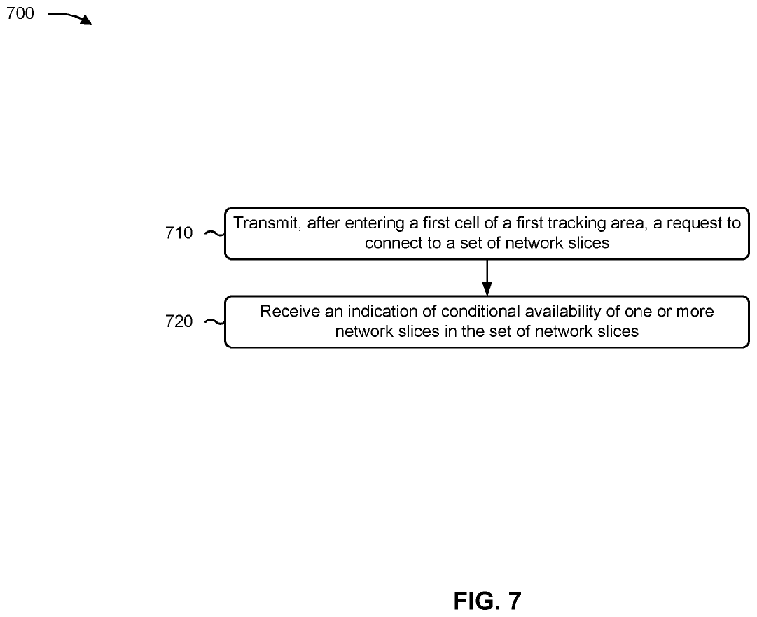

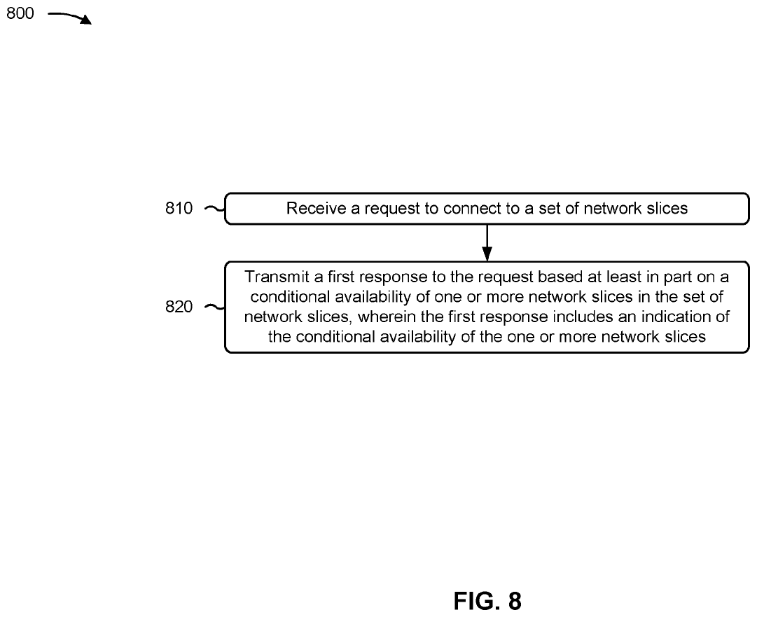

A controller/processor of a network entity (e.g., the controller/processor 290 of the network entity 130), the controller/processor 280 of the UE 120, and/or any other component(s) of FIG. 2 may perform one or more techniques associated with indicating conditional availability of network slices, as described in more detail elsewhere herein. For example, the controller/processor 290 of the network entity 130, the controller/processor 280 of the UE 120, and/or any other component(s) of FIG. 2 may perform or direct operations of, for example, process 700 of FIG. 7, process 800 of FIG. 8, and/or other processes as described herein. The memory 292 and the memory 282 may store data and program codes for the network entity 130 and the UE 120, respectively. In some examples, the memory 292 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity 130 and/or the UE 120, may cause the one or more processors, the UE 120, and/or the network entity 130 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for transmitting, after entering a first cell of a first tracking area, a request to connect to a set of network slices; and/or means for receiving an indication of conditional availability of one or more network slices in the set of network slices. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity 130 includes means for receiving a request to connect to a set of network slices; and/or means for transmitting a first response to the request based at least in part on a conditional availability of one or more network slices in the set of network slices, wherein the first response includes an indication of the conditional availability of the one or more network slices. In some aspects, the means for the network entity 130 to perform operations described herein may include, for example, one or more of communication manager 150, communication unit 294, controller/processor 290, and memory 292.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

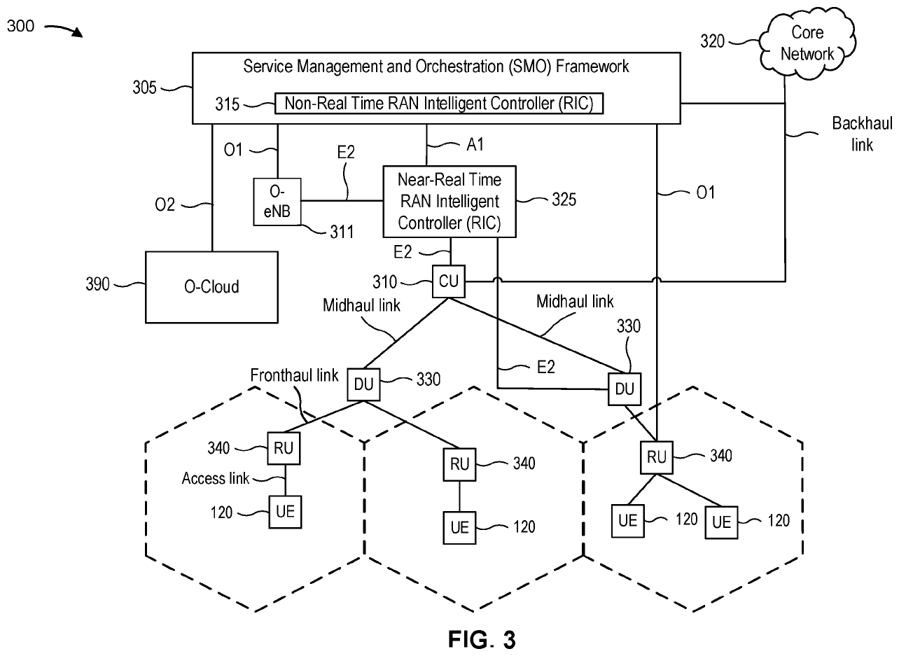

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 3 shows a diagram illustrating an example disaggregated base station 300 architecture. The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more radio frequency (RF) access links. In some aspects, the UE 120 may be simultaneously served by multiple RUs 340. The DUs 330 and the RUs 340 may also be referred to as “O-RAN DUS (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an Ol interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram of an example 400 of a core network configured to provide network slicing. As shown in FIG. 4, example 400 may include a UE 120, a wireless network 100, and a core network 320 (such as shown in FIG. 3). Devices and/or networks of example 400 may interconnect via wired connections, wireless connections, or a combination thereof.

The UE 120 may include one or more devices capable of receiving, generating, storing, processing, and/or providing information, such as information described herein. For example, the UE 120 may include a mobile phone (e.g., a smart phone or a radiotelephone, among other examples), a laptop computer, a tablet computer, a desktop computer, a handheld computer, a gaming device, a wearable communication device (e.g., a smart watch or a pair of smart glasses, among other examples), a mobile hotspot device, a fixed wireless access device, customer premises equipment, an autonomous vehicle, or a similar type of device.

The network 100 may support, for example, a cellular RAT. The wireless network 100 may include one or more base stations (e.g., base transceiver stations, radio base stations, node Bs, eNodeBs (eNBs), gNodeBs (gNBs), base station subsystems, cellular sites, cellular towers, access points, TRPs, radio access nodes, macrocell base stations, microcell base stations, picocell base stations, femtocell base stations, or similar types of devices) and other network entities that can support wireless communication for the UE 120. The network 100 may transfer traffic between the UE 120 (e.g., using a cellular RAT), one or more base stations (e.g., using a wireless interface or a backhaul interface, such as a wired backhaul interface), and/or the core network 320. The network 100 may provide one or more cells that cover geographic areas.

In some aspects, the network 100 may perform scheduling and/or resource management for the UE 120 covered by the network 100 (e.g., the UE 120 covered by a cell provided by the network 100). In some aspects, the network 100 may be controlled or coordinated by a network controller, which may perform load balancing and/or network-level configuration, among other examples. As described above in connection with FIG. 1, the network controller may communicate with the network 100 via a wireless or wireline backhaul. In some aspects, the network 100 may include a network controller, a self-organizing network (SON) module or component, or a similar module or component. Accordingly, the network 100 may perform network control, scheduling, and/or network management functions (e.g., for uplink, downlink, and/or sidelink communications of the UE 120 covered by the network 100).

In some aspects, the core network 320 may include an example functional architecture in which systems and/or methods described herein may be implemented. For example, the core network 320 may include an example architecture of a fifth generation (5G) next generation (NG) core network included in a 5G wireless telecommunications system. Although the example architecture of the core network 320 shown in FIG. 4 may be an example of a service-based architecture, in some aspects, the core network 320 may be implemented as a reference-point architecture and/or a 4G core network, among other examples.

As shown in FIG. 4, the core network 320 may include a number of functional elements that are network entities (e.g., network entity 130), that are included in network entities, or that split functionality with network entities. The functional elements may include, for example, a network slice selection function (NSSF) 410, a network exposure function (NEF) 415, an authentication server function (AUSF) 420, a unified data management (UDM) component 425, a policy control function (PCF) 430, an application function (AF) 435, an access and mobility management function (AMF) 440, a session management function (SMF) 445, and/or a user plane function (UPF) 450, among other examples. These functional elements may be communicatively connected via a message bus 455. Each of the functional elements shown in FIG. 4 may be implemented on one or more devices associated with a wireless telecommunications system. In some implementations, one or more of the functional elements may be implemented on physical devices, such as an access point, a base station, and/or a gateway, among other examples. In some implementations, one or more of the functional elements may be implemented on a computing device of a cloud computing environment.

The NSSF 410 may include one or more devices that select network slice instances for the UE 120. Network slicing is a network architecture model in which logically distinct network slices operate using common network infrastructure. This may include multiplexing virtual and independent logical networks on the same network infrastructure. For example, several network slices may operate as isolated end-to-end networks customized to satisfy different target service standards for different types of applications executed, at least in part, by the UE 120 and/or communications to and from the UE 120. Each network slice may be logically separated but use the same RAN, the same AMF, the same SMF, and the same or different UPFs. Network slicing may efficiently provide communications for different types of services with different service standards. For example, a first network slice may be for V2X applications, a second network slice may be for video streaming for mobile phones, and a third network slice may be for financial applications on mobile phones.

The NSSF 410 may determine a set of network slice policies to be applied at the network 100. For example, the NSSF 410 may apply one or more UE route selection policy (URSP) rules. In some aspects, the NSSF 410 may select a network slice based on a mapping of a data network name (DNN) field included in a route selection description (RSD) to the DNN field included in a traffic descriptor selected by the UE 120. By providing network slicing, the NSSF 410 allows an operator to deploy multiple substantially independent end-to-end networks potentially with the same infrastructure. In some implementations, each slice may be customized for different services. The operator may use a network services orchestrator (NSO) to provision slice services.

The NEF 415 may include one or more devices that support exposure of capabilities and/or events in the wireless telecommunications system to help other entities in the wireless telecommunications system discover network services. The AUSF 420 may include one or more devices that act as an authentication server and support the process of authenticating the UE 120 in the wireless telecommunications system.

The UDM 425 may include one or more devices that store user data and profiles in the wireless telecommunications system. In some aspects, the UDM 425 may be used for fixed access and/or mobile access, among other examples, in the core network 320.

The PCF 430 may include one or more devices that provide a policy framework that incorporates network slicing, roaming, packet processing, and/or mobility management, among other examples. In some aspects, the PCF 430 may include one or more URSP rules used by the NSSF 410 to select network slice instances for the UE 120.

The AF 435 may include one or more devices that support application influence on traffic routing, access to the NEF 415, and/or policy control, among other examples. The AMF 440 may include one or more devices that act as a termination point for non-access stratum (NAS) signaling and/or mobility management, among other examples. In some aspects, the AMF may request the NSSF 410 to select network slice instances for the UE 120, e.g., at least partially in response to a request for data service from the UE 120.

The SMF 445 may include one or more devices that support the establishment, modification, and release of communication sessions in the wireless telecommunications system. For example, the SMF 445 may configure traffic steering policies at the UPF 450 and/or enforce UE internet protocol (IP) address allocation and policies, among other examples. In some aspects, the SMF 445 may provision the network slice instances selected by the NSSF 410 for the UE 120.

The UPF 450 may include one or more devices that serve as an anchor point for intraRAT and/or interRAT mobility. In some aspects, the UPF 450 may apply rules to packets, such as rules pertaining to packet routing, traffic reporting, and/or handling user plane QOS, among other examples.

The message bus 455 may be a logical and/or physical communication structure for communication among the functional elements. Accordingly, the message bus 455 may permit communication between two or more functional elements, whether logically (e.g., using one or more application programming interfaces (APIs), among other examples) and/or physically (e.g., using one or more wired and/or wireless connections).

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of example 400 may perform one or more functions described as being performed by another set of devices of example environment 400.

A UE may use a network slice for an application for communication. The UE may select a protocol data unit (PDU) session associated with a network slice for the application. A UE may select the PDU session according to a URSP. The URSP may be preconfigured or signaled from a PCF entity to a UE via NAS signaling and/or via an AMF entity.

The UE may provide a registration request. This may include transmitting a single network slice selection assistance information (S-NSSAI) to convey an onboarding request with credentials. The UE may include, in the S-NSSAI, a slice service type (SST) indicator to indicate that the S-NSSAI is for the onboarding with credentials level of access. In some aspects, the SST indicator may be defined (e.g., in a specification) with a value indicating for what the slice is to be used. A network entity may receive the registration request, using an RRC message or an NAS message, and provide an NAS registration message to the AMF to indicate that the S-NSSAI is for the onboarding with credentials level of access. Network slice-specific authentication and authorization (NSSAA) may be triggered based at least in part on the S-NSSAI. The AMF may provide a registration accept message or a registration reject message. If the UE is successfully registered in an S-NSSAI, the UE may transmit a message to the AMF and/or the SMF/UPF to initiate PDU session establishment. For example, the SMF/UPF and the PCF may allow access to a specified IP address or port range for a PDU session established for the UE. The SMF/UPF may provide a PDU session establishment accept message and the UE may, based at least in part on receiving the PDU session establishment accept message, have an IP connection for random access (RA) in a data network.

As indicated above, FIG. 4 is provided as an example. Other examples may differ from what is described with regard to FIG. 4.

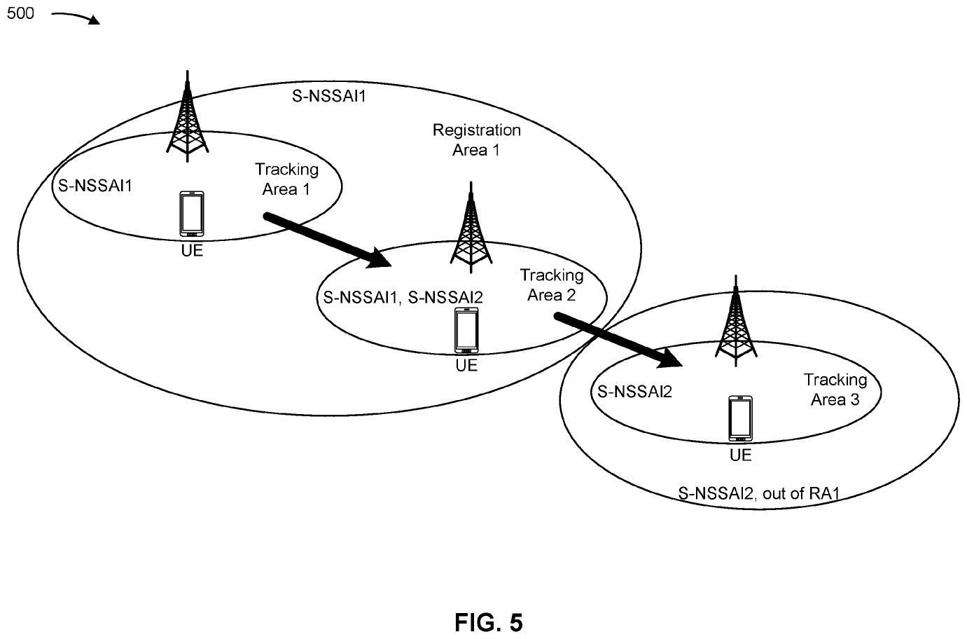

FIG. 5 is a diagram illustrating an example 500 of requesting network slices, in accordance with the present disclosure.

Example 500 shows a registration area (Registration Area 1) that includes a first tracking area (Tracking Area 1) and a second tracking area (Tracking Area 2). A third tracking area (Tracking Area 3) is outside of Registration Area 1 (RA1).

A UE (e.g., a UE 120) may enter a first cell of Tracking Area 1 and transmit a request to connect to a set of network slices (one or more network slices). The request may be an S-NSSAI (e.g., S-NSSAI2) in a requested NSSAI. However, the request may be rejected because the set of network slices (e.g., S-NSSAI2) is not supported in Tracking Area 1 (e.g., only S-NSSAI1 is supported in Tracking Area 1). S-NSSAI2 may be supported in a nearby tracking area (e.g., Tracking Area 2). The AMF may include nearby tracking areas in Registration Area 1, as it is optimal to do so for the S-NSSAIs in the allowed NSSAIs. The allowed NSSAI and allowed registration area are determined by the registration procedure performed by the AMF.

If the request is rejected, the rejection cause code is “not supported in the RA,” and the UE cannot attempt to register with the rejected set of network slices (e.g., S-NSSAI2) until the UE moves out of Registration Area 1. All S-NSSAIs of the allowed NSSAI for Registration Area 1 are available in all tracking areas of Registration Area 1 and thus all neighboring tracking areas that support the allowed NSSAI may be allocated into the same registration area. If this is not desirable, then the AMF can only assign a registration area that is limited to the current tracking area and tracking areas where the rejected S-NSSAI2 is not supported. This enables the UE to register with the rejected S-NSSAI2 when the UE moves into the nearby Tracking Area 2 that supports the rejected S-NSSAI2. A UE is expected to register with the network to become authorized to receive services, to enable mobility tracking, and to enable reachability. The UE initiates the registration procedure using an initial registration, a mobility registration update (e.g., upon changing to a new tracking area outside the registration area), a periodic registration update (due to a predefined time period of inactivity), or an emergency registration. The UE can initiate the registration procedure and update the allowed NSSAI only when it moves out of Registration Area 1.

Consequently, when the UE moves into Tracking Area 2, the allowed NSSAI will still be S-NSSAI1 and the UE cannot use S-NSSAI2, even though S-NSSAI2 is supported in Tracking Area 2. Only when the UE continues to move to Tracking Area 3, which is outside of Registration Area 1 (RA1), can the UE try to register to S-NSSAI2.

As indicated above, FIG. 5 is provided as an example. Other examples may differ from what is described with regard to FIG. 5.

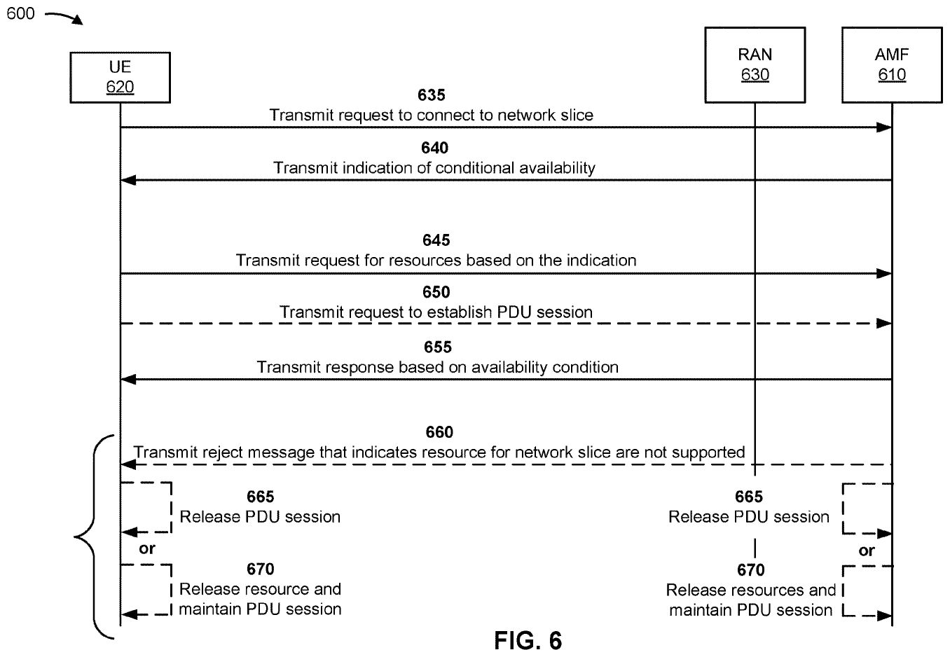

FIG. 6 is a diagram illustrating an example 600 of indicating conditional availability of network slices, in accordance with the present disclosure. As shown in FIG. 6, a network entity (e.g., an AMF 610) and a UE 620 (e.g., a UE 120) may communicate with one another via a RAN 630 (e.g., base station 110).

Currently, the AMF 610 may provide an allowed-NSSAI (A-NSSAI) that includes only S-NSSAIs that are allowed in the whole registration area. According to various aspects described herein, a rejected NSSAI (R-NSSAI) may indicate certain conditions during which an S-NSSAI is available, even within the same registration area. Such conditions may include one or more additional tracking areas where the S-NSSAI is available and/or a time availability of an S-NSSAI. The additional tracking areas may be applicable to, for example, applications that are associated with geographical locations (e.g., stadium, theme park). The time availability may be applicable to, for example, applications surrounding an event (e.g., sporting event, concert) that occurs during a time frame. That is, a new “conditionally allowed” NSSAI may be returned to the UE 120 that includes the S-NSSAIs that are allowed under specific conditions.

As shown by reference number 635, the UE 620 may transmit a request to connect to a network slice (or a set of network slices). The request may be a Registration request message where the UE 620 provides a list of the slices that the UE requests in a Requested NSSAI information element (IE). The UE 620 may transmit the request upon entering a cell or a tracking area (e.g., Tracking Area 1). The request may be rejected. However, rather than requiring the UE 120 to leave the registration area (Registration Area 1) and try again, the AMF 610 may provide conditions by which the UE 120 can connect to the network slice. As shown by reference number 640, the AMF 610 may transmit an indication of conditional availability of the network slice (and/or other network slices in the set of network slices).

The AMF 610 may include the indication in an IE. The IE may be specified for conditional availability information for network slices in a Conditional Accepted NSSAI, or specified for rejected network slices in a Rejected NSSAI where the cause for rejection indicates “conditional” and is associated with additional indications that indicate when the slice is available. The UE 120 may receive the indication in a registration accept message or a UE configuration update message. In some aspects, the UE 120 may receive, in a broadcast from a cell, one or more identifiers that indicate which services or slices are available in the cell.

In some aspects, after receiving the indication, the UE 120 may prepare to connect to a network slice that is conditionally available. As shown by reference number 645, the UE 620 may transmit a request for resources of the network slice (or slices) based at least in part on the indication of conditional availability. This may include transmitting a service request to establish a PDU session, as shown by reference number 650. The PDU session may be established based at least in part on the indication.

In an example, while in Tracking Area 1 of FIG. 5, the UE 620 may receive an indication that S-NSSAI2 is available in Tracking Area 2. The UE 620 may select a cell that includes Tracking Area 2 or otherwise select Tracking Area 2 to obtain resources for S-NSSAI2.

In another example, S-NSSAI2 may be conditionally available at a certain time (e.g., starting time, time duration). The UE 620, having received information about the temporal validity of the network slice in the indication, may transmit the request for resources for S-NSSAI2 at the appropriate time. The request may also be based at least in part on an identity of the current tracking area, an identity of the current cell, and/or a service identifier received in the current cell.

In some aspects, the indication of conditional availability may provide information about other conditions, including availability based at least in part on service identifiers or network slice identifiers that may be obtained to access an S-NSSAI within the registration area. Other conditions may involve UE capabilities, subscriptions, group membership, location, and/or UE type.

Consequently, the UE 620 may obtain access to S-NSSAI2 without having to leave Registration Area 1. As shown by reference number 655, the AMF 610 may transmit a response based at least in part on the availability condition of the network slice (or slices). For example, the AMF 610 may indicate, in the response, that the request is accepted. This response may be based at least in part on, for example, comparing a current tracking area to a tracking area condition or comparing a time of the request to a time condition. The response may also be based at least in part on comparing service, cell, slice, or tracking area identities or identifiers to qualifying identities or identifiers. Alternatively, the AMF 610 may indicate that the request is rejected. If so, the AMF 610 may provide additional reasons for the rejection and may provide conditional availability information in the response.

By indicating conditional availability information, the AMF 610 may enable the UE 620 to access a network slice and gain services provided on the network slice without having to exit a registration area. This may improve service availability and the user experience. This may also save time and signaling resources that would be consumed by other attempts to access the network slice.

In some scenarios, the UE 620 may move to a tracking area where access to a particular network slice (e.g., S-NSSAI) is not allowed, and a PDU session is either not allowed or released. For example, as shown by reference number 650, the UE 620 may have transmitted the service request to establish user plane resources for a PDU session associated with the network slice, based at least in part on the indication. The AMF 610 may transmit a PDU session request rejection or “Service Reject” message. Normally, this would be the end of the process. However, in some aspects, as shown by reference number 660, the AMF 610 may include a new cause code or other information in the rejection message that indicates that resources for the network slice (or slices) are not supported or available and that this is the cause for the rejection message. As shown by reference number 665, the UE 620 and the AMF 610 may release the PDU session (trigger the SMF to release the PDU session). The UE 620 may use this information for future requests.

Alternatively, in some aspects, as shown by reference number 670, the AMF 610 and the UE 620 do not release the PDU session and release only the radio resources (e.g., radio bearer). The UE 620 may maintain the PDU session, and the AMF 610 may have the SMF maintain the PDU session. For downlink data, the AMF 610 may inform the SMF that the slice or the resources are not available. This may make the Session Management (SM) procedure depend on the current tracking area. By providing a cause code and/or maintaining a PDU session, the UE 620 and the AMF 610 may conserve signaling resources that would otherwise be consumed by setting up a PDU session. In some aspects, the AMF 610 may transmit a service reject message may, in response receiving a service request message, indicate that resources for a network slice (or set of network slices) are not supported. The AMF 610 and the UE 620 may release the PDU session, or alternatively, release resources for the PDU session but maintain the PDU session.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120, UE 620) performs operations associated with conditionally available network slices.

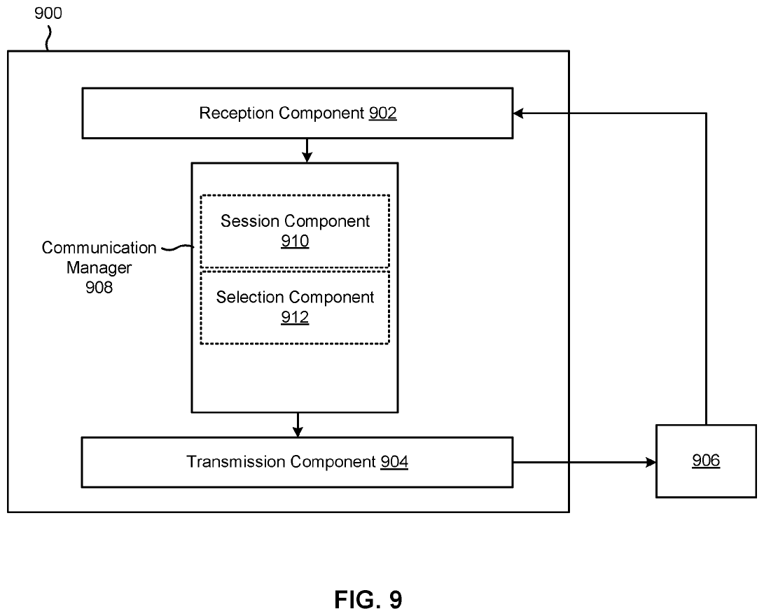

As shown in FIG. 7, in some aspects, process 700 may include transmitting, after entering a first cell of a first tracking area, a request to connect to a set of network slices (block 710). For example, the UE (e.g., using communication manager 908 and/or transmission component 904 depicted in FIG. 9) may transmit, after entering a first cell of a first tracking area, a request to connect to a set of network slices, as described above.

As further shown in FIG. 7, in some aspects, process 700 may include receiving an indication of conditional availability of one or more network slices in the set of network slices (block 720). For example, the UE (e.g., using communication manager 908 and/or reception component 902 depicted in FIG. 9) may receive an indication of conditional availability of one or more network slices in the set of network slices, as described above.

Process 700 may include additional aspects, such as any single aspect or any combination of aspects described below and/or in connection with one or more other processes described elsewhere herein.

In a first aspect, receiving the indication includes receiving the indication in an IE that is specified for conditional availability information for network slices.

In a second aspect, alone or in combination with the first aspect, receiving the indication includes receiving the indication in an IE that is specified for rejected network slices.

In a third aspect, alone or in combination with one or more of the first and second aspects, receiving the indication includes receiving the indication in a registration accept message or a UE configuration update message.

In a fourth aspect, alone or in combination with one or more of the first through third aspects, process 700 includes receiving, from a cell, a broadcast that includes one or more identifiers that indicate which services or slices are available in the cell.

In a fifth aspect, alone or in combination with one or more of the first through fourth aspects, process 700 includes transmitting a request for resources of the one or more network slices based at least in part on the indication.

In a sixth aspect, alone or in combination with one or more of the first through fifth aspects, transmitting the request includes transmitting the request at a time when the one or more network slices are available based at least in part on one or more of the indication, an identity of the first tracking area, an identity of the first cell, or a service identifier received in the first cell.

In a seventh aspect, alone or in combination with one or more of the first through sixth aspects, transmitting the request includes transmitting a service request to establish user plane resources for a PDU session associated with the one or more network slices, based at least in part on the indication.

In an eighth aspect, alone or in combination with one or more of the first through seventh aspects, process 700 includes receiving a PDU session request rejection message that indicates that resources for the set of network slices are not supported, and releasing the PDU session.

In a ninth aspect, alone or in combination with one or more of the first through eighth aspects, process 700 includes receiving a PDU session request rejection message that indicates that resources for the set of network slices are not supported, and releasing resources for the PDU session while maintaining the PDU session.

In a tenth aspect, alone or in combination with one or more of the first through ninth aspects, process 700 includes receiving a service reject message that indicates that resources for the set of network slices are not supported. Process 700 may further include releasing resources for a PDU session while maintaining the PDU session.

In an eleventh aspect, alone or in combination with one or more of the first through tenth aspects, process 700 includes selecting a second cell in the first tracking area or a second tracking area based at least in part on the indication.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network entity, in accordance with the present disclosure. Example process 800 is an example where the network entity (e.g., network entity, AMF 610) performs operations associated with conditionally available network slices.

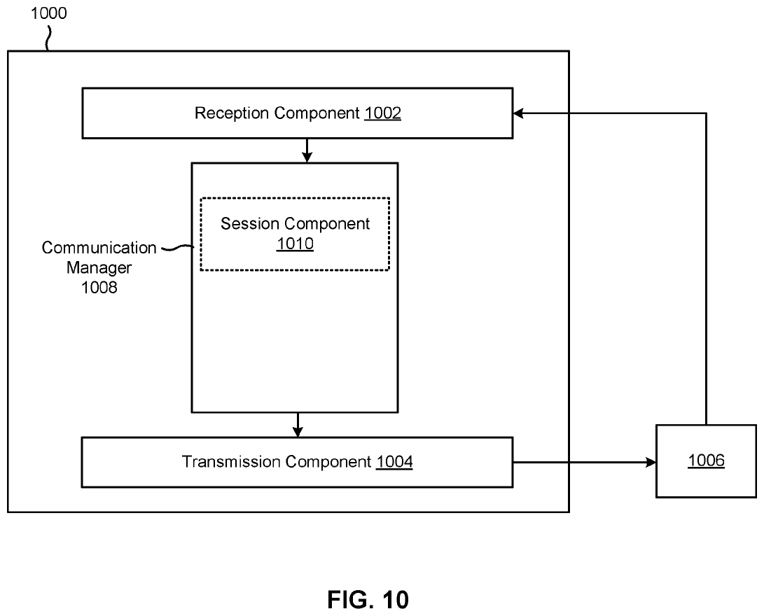

As shown in FIG. 8, in some aspects, process 800 may include receiving a request to connect to a set of network slices (block 810). For example, the network entity (e.g., using communication manager 1008 and/or reception component 1002 depicted in FIG. 10) may receive a request to connect to a set of network slices, as described above.

As further shown in FIG. 8, in some aspects, process 800 may include transmitting a first response to the request based at least in part on a conditional availability of one or more network slices in the set of network slices, where the first response includes an indication of the conditional availability of the one or more network slices (block 820). For example, the network entity (e.g., using communication manager 1008 and/or transmission component 1004 depicted in FIG. 10) may transmit a first response to the request based at least in part on a conditional availability of one or more network slices in the set of network slices, where the first response includes an indication of the conditional availability of the one or more network slices, as described above.

Process 800 may include additional aspects, such as any single aspect or any combination of aspects described below and/or in connection with one or more other processes described elsewhere herein.

In a first aspect, the indication is included in an IE that is specified for conditional availability information for network slices.

In a second aspect, alone or in combination with the first aspect, the indication is included in an IE that is specified for rejected network slices.

In a third aspect, alone or in combination with one or more of the first and second aspects, the indication is included in a registration accept message or a UE configuration update message.

In a fourth aspect, alone or in combination with one or more of the first through third aspects, process 800 includes receiving, in response to transmitting the indication, a request for resources of the one or more network slices, and transmitting a second response that indicates an acceptance or rejection based at least in part on the conditional availability of the one or more network slices.

In a fifth aspect, alone or in combination with one or more of the first through fourth aspects, the second response is based at least in part on a time of the request for the resources and on the conditional availability of the one or more network slices at the time.

In a sixth aspect, alone or in combination with one or more of the first through fifth aspects, the network entity includes an AMF.

In a seventh aspect, alone or in combination with one or more of the first through sixth aspects, receiving the request includes receiving a service request to establish user plane resources for a PDU session associated with the one or more network slices, and process 800 includes transmitting a PDU session request rejection message that indicates that resources for the set of network slices are not supported and releasing the PDU session.

In an eighth aspect, alone or in combination with one or more of the first through seventh aspects, receiving the request includes receiving a service request to establish user plane resources for a PDU session associated with the one or more network slices, and process 800 includes transmitting a PDU session request rejection message that indicates that resources for the set of network slices are not supported, and releasing resources for the PDU session while maintaining the PDU session.

In a ninth aspect, alone or in combination with one or more of the first through eighth aspects, process 800 includes transmitting a service reject message that indicates that resources for the set of network slices are not supported. Process 800 may further includes releasing resources for a PDU session while maintaining the PDU session.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE (e.g., a UE 120, UE 620), or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 908. The communication manager 908 may control and/or otherwise manage one or more operations of the reception component 902 and/or the transmission component 904. In some aspects, the communication manager 908 may include one or more antennas, a modem, a controller/processor, a memory, or a combination thereof, of the base station described in connection with FIG. 2. The communication manager 908 may be, or be similar to, the communication manager 140 depicted in FIGS. 1 and 2. For example, in some aspects, the communication manager 908 may be configured to perform one or more of the functions described as being performed by the communication manager 140. In some aspects, the communication manager 908 may include the reception component 902 and/or the transmission component 904. The communication manager 908 may include a session component 910 and/or a selection component 912, among other examples.

In some aspects, the apparatus 900 may be configured to perform one or more operations described herein in connection with FIGS. 1-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The transmission component 904 may transmit, after entering a first cell of a first tracking area, a request to connect to a set of network slices. The reception component 902 may receive an indication of conditional availability of one or more network slices in the set of network slices. The reception component 902 may receive, from a cell, a broadcast that includes one or more identifiers that indicate which services or slices are available in the cell.

The transmission component 904 may transmit a request for resources of the one or more network slices based at least in part on the indication.

The transmission component 904 may transmit a service request to establish user plane resources for a PDU session associated with the one or more network slices, based at least in part on the indication. The reception component 902 may receive a PDU session request rejection message that indicates that resources for the set of network slices are not supported. The session component 910 may release the PDU session. The session component 910 may release resources for the PDU session while maintaining the PDU session.

The selection component 912 may select a second cell in the first tracking area or a second tracking area based at least in part on the indication.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network entity (e.g., AMF 610), or a network entity may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 1008. The communication manager 1008 may control and/or otherwise manage one or more operations of the reception component 1002 and/or the transmission component 1004. In some aspects, the communication manager 1008 may include one or more antennas, a modem, a controller/processor, a memory, or a combination thereof, of the base station described in connection with FIG. 2. The communication manager 1008 may be, or be similar to, the communication manager 150 depicted in FIGS. 1 and 2. For example, in some aspects, the communication manager 1008 may be configured to perform one or more of the functions described as being performed by the communication manager 150. In some aspects, the communication manager 1008 may include the reception component 1002 and/or the transmission component 1004. The communication manager 1008 may include a session component 1010, among other examples.

In some aspects, the apparatus 1000 may be configured to perform one or more operations described herein in connection with FIGS. 1-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network entity described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network entity described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network entity described in connection with FIG. 2. In some aspects, the transmission component 1004 may be co-located with the reception component 1002 in a transceiver.

The reception component 1002 may receive a request to connect to a set of network slices. The transmission component 1004 may transmit a first response to the request based at least in part on a conditional availability of one or more network slices in the set of network slices, wherein the first response includes an indication of the conditional availability of the one or more network slices.

The reception component 1002 may receive, in response to transmitting the indication, a request for resources of the one or more network slices. The transmission component 1004 may transmit a second response that indicates an acceptance or rejection based at least in part on the conditional availability of the one or more network slices.

The reception component 1002 may receive a service request to establish user plane resources for a PDU session associated with the one or more network slices. The transmission component 1004 may transmit a PDU session request rejection message that indicates that resources for the set of network slices are not supported. The session component 1010 may release the PDU session. The session component 1010 may release resources for the PDU session while maintaining the PDU session.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: transmitting, after entering a first cell of a first tracking area, a request to connect to a set of network slices; and receiving an indication of conditional availability of one or more network slices in the set of network slices.

Aspect 2: The method of Aspect 1, wherein receiving the indication includes receiving the indication in an information element that is specified for conditional availability information for network slices.

Aspect 3: The method of Aspect 1, wherein receiving the indication includes receiving the indication in an information element that is specified for rejected network slices.

Aspect 4: The method of any of Aspects 1-3, wherein receiving the indication includes receiving the indication in a registration accept message or a UE configuration update message.

Aspect 5: The method of any of Aspects 1-4, further comprising receiving, from a cell, a broadcast that includes one or more identifiers that indicate which services or slices are available in the cell.

Aspect 6: The method of any of Aspects 1-5, further comprising transmitting a request for resources of the one or more network slices based at least in part on the indication.

Aspect 7: The method of Aspect 6, wherein transmitting the request includes transmitting the request at a time when the one or more network slices are available based at least in part on one or more of the indication, an identity of the first tracking area, an identity of the first cell, or a service identifier received in the first cell.

Aspect 8: The method of Aspect 6 or 7, wherein transmitting the request includes transmitting a service request to establish user plane resources for a protocol data unit (PDU) session associated with the one or more network slices, based at least in part on the indication.

Aspect 9: The method of Aspect 8, further comprising: receiving a PDU session request rejection message that indicates that resources for the set of network slices are not supported; and releasing the PDU session.

Aspect 10: The method of Aspect 8, further comprising: receiving a PDU session request rejection message that indicates that resources for the set of network slices are not supported; and releasing resources for the PDU session while maintaining the PDU session.

Aspect 11: The method of any of Aspects 1-10, further comprising selecting a second cell in the first tracking area or a second tracking area based at least in part on the indication.

Aspect 12: The method of any of Aspects 1-11, further comprising: receiving a service reject message that indicates that resources for the set of network slices are not supported; and releasing resources for a protocol data unit (PDU) session while maintaining the PDU session.

Aspect 13: A method of wireless communication performed by a network entity, comprising: receiving a request to connect to a set of network slices; and transmitting a first response to the request based at least in part on a conditional availability of one or more network slices in the set of network slices, wherein the first response includes an indication of the conditional availability of the one or more network slices.

Aspect 14: The method of Aspect 13, wherein the indication is included in an information element that is specified for conditional availability information for network slices.

Aspect 15: The method of Aspect 13, wherein the indication is included in an information element that is specified for rejected network slices.

Aspect 16: The method of any of Aspects 13-15, wherein the indication is included in a registration accept message or a UE configuration update message.

Aspect 17: The method of any of Aspects 13-16, further comprising: receiving, in response to transmitting the indication, a request for resources of the one or more network slices, and transmitting a second response that indicates an acceptance or rejection based at least in part on the conditional availability of the one or more network slices.

Aspect 18: The method of Aspect 17, wherein the second response is based at least in part on a time of the request for the resources and on the conditional availability of the one or more network slices at the time.

Aspect 19: The method of any of Aspects 13-18, wherein the network entity includes an access and mobility management function.

Aspect 20: The method of any of Aspects 13-19, wherein receiving the request includes receiving a service request to establish user plane resources for a protocol data unit (PDU) session associated with the one or more network slices, and wherein the method may include: transmitting a PDU session request rejection message that indicates that resources for the set of network slices are not supported; and releasing the PDU session.

Aspect 21: The method of any of Aspects 13-19, wherein receiving the request includes receiving a service request to establish user plane resources for a protocol data unit (PDU) session associated with the one or more network slices, and wherein the method may include transmitting a PDU session request rejection message that indicates that resources for the set of network slices are not supported; and releasing resources for the PDU session while maintaining the PDU session.

Aspect 22: The method of any of Aspects 13-21, further comprising:
transmitting a service reject message that indicates that resources for the set of network slices are not supported; and releasing resources for a protocol data unit (PDU) session while maintaining the PDU session.

Aspect 23: An apparatus for wireless communication at a device, comprising a processor; memory coupled with the processor; and instructions stored in the memory and executable by the processor to cause the apparatus to perform the method of one or more of Aspects 1-22.

Aspect 24: A device for wireless communication, comprising a memory and one or more processors coupled to the memory, the one or more processors configured to perform the method of one or more of Aspects 1-22.

Aspect 25: An apparatus for wireless communication, comprising at least one means for performing the method of one or more of Aspects 1-22.

Aspect 26: A non-transitory computer-readable medium storing code for wireless communication, the code comprising instructions executable by a processor to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit, after entering a first cell of a first tracking area, a request to connect to a set of network slices; and
receive an indication of conditional availability of one or more network slices in the set of network slices.

2. The UE of claim 1, wherein the one or more processors, to receive the indication, are configured to receive the indication in an information element that is specified for conditional availability information for network slices.

3. The UE of claim 1, wherein the one or more processors, to receive the indication, are configured to receive the indication in an information element that is specified for rejected network slices.

4. The UE of claim 1, wherein the one or more processors, to receive the indication, are configured to receive the indication in a registration accept message or a UE configuration update message.

5. The UE of claim 1, wherein the one or more processors are configured to receive, from a cell, a broadcast that includes one or more identifiers that indicate which services or slices are available in the cell.

6. The UE of claim 1, wherein the one or more processors are configured to transmit a request for resources of the one or more network slices based at least in part on the indication.

7. The UE of claim 6, wherein the one or more processors, to transmit the request, are configured to transmit the request at a time when the one or more network slices are available based at least in part on one or more of the indication, an identity of the first tracking area, an identity of the first cell, or a service identifier received in the first cell.

8. The UE of claim 6, wherein the one or more processors, to transmit the request, are configured to transmit a service request to establish user plane resources for a protocol data unit (PDU) session associated with the one or more network slices, based at least in part on the indication.

9. The UE of claim 8, wherein the one or more processors are configured to:
receive a PDU session request rejection message that indicates that resources for the set of network slices are not supported; and
release the PDU session.

10. The UE of claim 8, wherein the one or more processors are configured to:
receive a PDU session request rejection message that indicates that resources for the set of network slices are not supported; and
release resources for the PDU session while maintaining the PDU session.

11. The UE of claim 8, wherein the one or more processors are configured to:
receive a service reject message that indicates that resources for the set of network slices are not supported; and
release resources for a protocol data unit (PDU) session while maintaining the PDU session.

12. The UE of claim 1, wherein the one or more processors are configured to select a second cell in the first tracking area or a second tracking area based at least in part on the indication.

13. A network entity for wireless communication, comprising:
a memory; and
one or more processors, coupled to the memory, configured to:
receive a request to connect to a set of network slices; and
transmit a first response to the request based at least in part on a conditional availability of one or more network slices in the set of network slices, wherein the first response includes an indication of the conditional availability of the one or more network slices.

14. The network entity of claim 13, wherein the indication is included in an information element that is specified for conditional availability information for network slices.

15. The network entity of claim 13, wherein the indication is included in an information element that is specified for rejected network slices.

16. The network entity of claim 13, wherein the indication is included in a registration accept message or a UE configuration update message.

17. The network entity of claim 13, wherein the one or more processors are configured to:
receive, in response to transmitting the indication, a request for resources of the one or more network slices; and
transmit a second response that indicates an acceptance or rejection based at least in part on the conditional availability of the one or more network slices.

18. The network entity of claim 17, wherein the second response is based at least in part on a time of the request for the resources and on the conditional availability of the one or more network slices at the time.

19. The network entity of claim 13, wherein the network entity includes an access and mobility management function.

20. The network entity of claim 13, wherein the one or more processors, to receive the request, are configured to receive a service request to establish user plane resources for a protocol data unit (PDU) session associated with the one or more network slices, and wherein the one or more processors are configured to:
transmit a PDU session request rejection message that indicates that resources for the set of network slices are not supported; and
release the PDU session.

21. The network entity of claim 13, wherein the one or more processors, to receive the request, are configured to receive a service request to establish user plane resources for a protocol data unit (PDU) session associated with the one or more network slices, and wherein the one or more processors are configured to:
transmit a PDU session request rejection message that indicates that resources for the set of network slices are not supported; and
release resources for the PDU session while maintaining the PDU session.

22. The network entity of claim 13, wherein the one or more processors are configured to:
transmit a service reject message that indicates that resources for the set of network slices are not supported; and
release resources for a protocol data unit (PDU) session while maintaining the PDU session.

23. A method of wireless communication performed by a user equipment (UE), comprising:
transmitting, after entering a first cell of a first tracking area, a request to connect to a set of network slices; and
receiving an indication of conditional availability of one or more network slices in the set of network slices.

24. The method of claim 23, wherein receiving the indication includes receiving the indication in an information element that is specified for conditional availability information for network slices.

25. The method of claim 23, wherein receiving the indication includes receiving the indication in an information element that is specified for rejected network slices.

26. The method of claim 23, wherein receiving the indication includes receiving the indication in a registration accept message or a UE configuration update message.

27. The method of claim 23, further comprising receiving, from a cell, a broadcast that includes one or more identifiers that indicate which services or slices are available in the cell.

28. The method of claim 23, further comprising transmitting a request for resources of the one or more network slices based at least in part on the indication.

29. A method of wireless communication performed by a network entity, comprising:
receiving a request to connect to a set of network slices; and
transmitting a first response to the request based at least in part on a conditional availability of one or more network slices in the set of network slices, wherein the first response includes an indication of the conditional availability of the one or more network slices.

30. The method of claim 29, wherein the indication is included in an information element that is specified for conditional availability information for network slices or specified for rejected network slices.
